(19) United States
(12) Patent Application Publication
(10) Pub. No.: US 2003/0224340 A1
(43) Pub. Date: Dec. 4, 2003

(54) Constructed response scoring system

(75) Inventors: Coy C. Housman, Broken Arrow, OK (US); Gregory Allen Jennings, Edmond, OK (US); Michael E. Payne, Perkins, OK (US); Stephen R. Daily, Stillwater, OK (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(73) Assignee: VSC Technologies, LLC

(21) Appl. No.: 10/452,859

(22) Filed: Jun. 2, 2003

Related U.S. Application Data
(60) Provisional application No. 60/384,440, filed on May 31, 2002.
(60) Provisional application No. 60/387,100, filed on Jun. 7, 2002.

(51) Int. Cl. G09B 7/00

(52) U.S. Cl. 434/353

(57) ABSTRACT

According to a first preferred aspect of the instant invention, there is provided a method of test scoring, wherein a bi-tonal image of a constructed response test answer is transmitted to a scorer and, if requested by the scorer, a multi-tonal image of that same image is transmitted. In another preferred arrangement, while a scorer is reviewing a first transmitted test answer, a second image will be transmitted and stored as a hidden graphic on his or her computer, thereby making it possible to immediately display the second image when requested. According to still another preferred arrangement, a method is provided of transmitting to a scorer a portion of a test answer sheet that is larger than the Area of Interest for the assigned answer and then, after a predetermined time delay, automatically zooming the image view to include only the Area of Interest.

### RELATED CASES

Applicants hereby claim priority to, and incorporate herein by reference, the disclosures contained in their U.S. Provisional Patent Applications filed on May 31, 2002 and Jun. 7, 2002, both entitled “Constructed Response Scoring System,” having Serial Nos. 60/384,440 and 60/387,100 respectively.

### CONSTRUCTED RESPONSE SCORING SYSTEM

The present invention relates to the general subject matter of scanning and grading selected response and constructed response tests and, more particularly, to systems, methods and apparatus for automating the process of grading constructed response based tests.

### BACKGROUND OF THE INVENTION

Standardized tests and other similar tests that are administered on a large scale remain a mainstay of the education industry. Broadly speaking there are two sorts of questions that might be found on such tests: selected response questions and constructed response questions (sometimes loosely referred to respectively as objective and non-objective questions). In the case of selected response questions—and according to a typical scenario—the respondent/test taker is provided with a predetermined list of numbered (or lettered) answers to each proffered question. The test taker then selects an answer from among those presented and indicates his or her chosen response by marking within a predetermined region (usually on a separate answer sheet) that corresponds to the number (or letter) of the chosen answer. The grading of such tests is readily automated and there are any number of methods of doing that sort of automation. For example, in one typical arrangement, the form that contains the user's marks is “read” by an optical mark recognition scanner (OMR) which determines which responses the user has designated and tabulates those responses for later reporting. Of course, most people are introduced to such machine-readable forms when they take their first standardized test, wherein the user fills in “bubbles” to signify which answer to a multiple choice question is felt to be most correct.

On the other hand, constructed response or non-objective tests allow the test taker to formulate an answer to the posed question in his or her own words, e.g., the test taker is asked to provide an essay, short answer or “fill-in-the-blank” answer. As might be expected, such hand-written responses are not readily susceptible to automatic (e.g., computer-based) scoring. The grading process for these sorts of answers has been—and remains—largely a manual one, which often requires multiple scorers (who may instead be called raters, graders, readers, or some other designation) to review each test taker's answer and independently provide an assessment. Of course, since the grading process for these sorts of answers is at least partly subjective, there can be a concern regarding the reliability of the resulting score Hence, multiple independent graders may be used to provide an enhanced level of confidence that a student's score has been fairly determined.

Although the scoring of constructed response tests cannot readily be automated, it is possible to automate much of the process of scoring those tests. A common first step in such automation is to reduce the test-taker's answer sheet(s) to digital form via optical scanning. As is well known to those of ordinary skill in the art, such scanning conventionally takes the form of obtaining bi-tonal images (e.g., black and white/zero-one/one-bit per pixel images) of the test taker's answer pages. Bi-tonal image representations have traditionally been used because they take up much less storage space than multi-tonal images. Additionally, it has heretofore been the conventional wisdom that multi-tonal images were not necessary in that all of the information that would be necessary to accurately score an answer could be obtained from bi-tonal images.

One reason to reduce each test to digital form is that the scorers can then be located remotely from the scoring center. Having the test answers available in digital form means that they can be transmitted over broadly-based networks such as the Internet to such scorers. The many advantages of such an arrangement should be clear when measured against the alternative of transmitting paper copies of the tests to each remotely situated scorer.

Thus, as a next step in the automated scoring process, a digital copy of each answer that has been assigned to a particular scorer is provided to him or her. The digital images might be either transmitted electronically or via surface mail (e.g., if the image file has been written to CD-ROM or other storage media). In a common arrangement, each scorer connects via the Internet to a central database/server that contains the scanned images of all of the answers for all of the test takers. Then, each scorer utilizes software such as a conventional Internet browser to successively access and view his or her assigned test answers.

Additionally, since it is conventional that each scorer will grade only a subset of the answers on a test, systems and methods have been developed for automatically extracting digital images that contain those answers from a scanned image of the test taker's page (or pages) of answers for transmission to the scorer. Such extraction makes more efficient use of the scorer's time and reduces the bandwidth that is necessary to transmit the answers to the scorer. Conventionally, the parameters of the extracted images are pre-determined based on an assumption that test takers will write their responses entirely within designated areas on their answer sheet(s).

However, there are problems with the conventional arrangement. First, transmission of the scanned images of the answers to the scorers can prove to be quite time consuming when the scorer is connected to the Internet via a 56K or slower modem. Thus, anything that tends to reduce the wait-time on the scorer's end would serve to increase productivity. Additionally, in the case of constructed response tests, the test takers may write outside of the designated areas. It may be desirable to read this additional text in order to correctly score the answer. However, if the scorer is only sent the exact portion of the test containing the answer that he or she is to grade (as is often done), the scorer may not notice that the answer as-transmitted is incomplete, may not request the remainder of the answer written by the test taker, and may therefore incorrectly score the answer.

Additionally, an ever-present concern with any testing organization is that the scoring be uniform when measured across different scorers. To that end it is common to give the same test answer to two different scorers to score. In the case where the scorers more or less agree in their assessment, it is common to accept the average or some other central measure as the “actual” score. However, in some circumstances, e.g., where the scorers differ “markedly” in their respective scoring, it may not be clear how to automatically recognize and resolve this difference of opinion.

Further, and as it is well known to those of ordinary skill in the art, it is common to assign validation answers to each scorer from time to time. These answers, for which “correct” scores have already been determined, are assigned to the scorer in order to assess whether or not that scorer is awarding scores that are consistent with the norm as established by the test preparer. However, the use of such answers should obviously be minimized, as scoring these answers takes time away from scoring the actual exam.

Finally, in some cases it might be deemed necessary to review the historical responses of a scorer who has been presented with validation answers.

Thus, what is needed is a test scoring system that addresses and solves the above-identified problems. However, before proceeding to a description of the present invention, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

### SUMMARY OF THE INVENTION

According to a first preferred embodiment of the instant invention, there is provided a constructed response scoring system that utilizes gray scale or color (rather than “one-bit” or bi-tonal) scanned images of the test-taker's answer page. In the preferred arrangement, each test answer page will be scanned as a gray scale or color (“multi-tonal” hereinafter) image and stored in that format on a central server. According to conversion methods well known to those of ordinary skill in the art, each test image will be converted to a bi-tonal image for electronic transmission to a scorer—who could potentially be located remotely from the central server that contains the scanned images of the test taker's response. In each case, the scorer is first sent electronically a bi-tonal image of the pages of an exam that he or she has been asked to grade. Then, if the transmitted image does not have sufficient clarity to enable the scorer to unambiguously read the scanned answer(s), the scorer can request that the server transmit the multi-tonal version of that same page. This method has the advantage of generally reducing the bandwidth that is necessary to transmit images to a scorer, while making it possible for a scorer to optionally request and view the more detailed information contained within the multi-tonal image if that is desired.

According to another preferred aspect of the instant invention, there is provided a system for display of a raster image of a test taker's answer page to a scorer that utilizes a conventional Internet browser (e.g., Microsoft Internet Explorer) to display the test image. In the preferred arrangement, a first test answer-page is electronically transmitted to a browser window on the scorer's computer. Simultaneously, and essentially invisibly to the scorer, the “next likely” page is transmitted to his or her browser while the scorer is evaluating the page that is currently displayed. Preferably, the browser will be instructed to display the next image as a single line of rasters, i.e., as an image 1 pixel high and as wide as the actual viewing window, within the same window that contains the current page. Then, when the scorer is ready to move on to the next page, that page has already been pre-loaded into the browser's cache and can then be immediately displayed to the user upon request.

According to still another preferred arrangement, the scorer is initially provided with an image of the entire page that contains the answer that is to be graded. Preferably the “area of interest” (“AOI”) relevant to the particular question which is to be scored will be digitally “highlighted” on this whole page image. That is, as each new answer sheet is presented, the AOI of the answer that is to be graded is first shown to the scorer within the context of the entire answer page. The scorer will then subsequently—and preferably automatically—be presented with only the AOI after a delay of a few moments, i.e., the software “zooms in” on the AOI for the current answer. Of course, if the scorer so desires, he or she can request that the original full-page view be redisplayed at any time.

According to still another preferred arrangement, there is provided a system and method of automatically determining when another scorer should be consulted in connection with the score that has been assigned to a particular answer. That is, it is most common to have either one or two scorers independently score/evaluate each answer. In some cases, though, the scorers will differ substantially as to the score that should be awarded to the same answer. In such a case, the instant inventors have determined a method of automatically determining when an additional scorer should be consulted. In one preferred embodiment, if the numerical difference between the two scorers' scores exceeds one or some other predetermined value, a third rater will be consulted.

According to another preferred arrangement, there is provided a system and method for evaluating scorers by presenting validation answers thereto, wherein the frequency with which the validation answers are presented is made a function of the experience level or other characteristics of the scorer. That is, in a preferred embodiment scorers with less experience (or, for example, scorers who have performed poorly in prior validation reviews) will be given validation answers more frequently than those with more experience (or better prior performance) in scoring.

Finally, and according to still another preferred embodiment, there is provided a rating system for use by a scorer of constructed response tests, wherein the scorer is presented with a validation answer, after which the scorer's response is stored in a central server or similar computer which is in electronic communication with that of the scorer. Optionally, this system can be used to train scorers. In that case, the answers having known “correct” scores typically are referred to as “calibration” (rather than “validation”) answers or items. When calibration answers are used, the scorers will first score the answer and then be presented with the correct response, thereby allowing him or her to study the correct score for the calibration answer and potentially improve his or her grading performance. It should be noted that for purposes of the instant disclosure the terms “control item” and “control answer” will be used to refer generally to both calibration-type and validation-type answers.

The foregoing has outlined in broad terms the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Additionally, the disclosure that follows is intended to cover all alternatives, modifications and equivalents as may be included within the spirit and scope of the invention as defined by the appended claims. Further, it should be understood that the phraseology and terminology employed herein are for the purpose of description and should not be regarded as limiting, unless the specification specifically so limits the invention. Further objects, features, and advantages of the present invention will be apparent upon examining the accompanying drawings and upon reading the following description of the preferred embodiments.

### BRIEF DESCRIPTION OF THE DRAWINGS

Other objects and advantages of the invention will become apparent upon reading the following detailed description and upon reference to the drawings in which:

FIG. 1 provides a schematic illustration of the general background of the invention.

FIG. 2 illustrates a preferred embodiment of the instant invention wherein a one-bit per pixel image is first sent to a scorer with a subsequent color or multi-tonal image of the same answer being sent only upon request.

FIG. 3 contains a summary of the preferred steps in the aspect of the instant invention that utilizes preloaded hidden graphics to speed the scoring of answer items by a scorer.

FIG. 4 illustrates an embodiment of the instant invention wherein a graphic image that is larger than the AOI and includes it is first presented to the scorer, followed automatically by display of the actual AOI of that test answer.

FIG. 5 contains the preferred steps in a method of automatically consulting a third scorer when two scorers do not agree on the score that is to be assigned to a particular test answer.

FIG. 6 illustrates a system and method for determining whether or not a scorer should be sent a validation answer, rather than an actual test answer, based on the experience of the scorer.

FIG. 7 contains a flow chart that outlines the preferred steps in a system and method of training scorers by using calibration answers.

### DETAILED DESCRIPTION OF THE PREFERRED EMBODIMENTS TEST PREPARATION

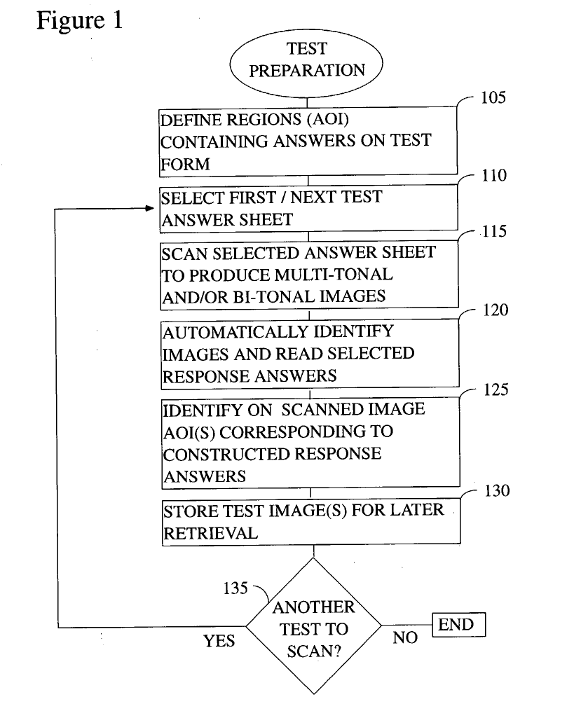

The instant invention deals generally with the scoring of constructed response answers. As is generally indicated in FIG. 1, as a first preferred step 105 in automating the scoring process, the AOI that encompasses the expected constructed response answer regions will be defined for each test page. Each AOI will typically define a rectangular region on the test answer sheet and could be in any number of different forms (e.g., two coordinate pairs that define a rectangle on the page, a coordinate pair plus a vertical distance down the page that defines a rectangle, etc.). Of course, the shape of the AOI—whether rectangular, triangular, round, etc.—is unimportant to the operation of the instant invention. Further, and as is well known to those of ordinary skill in the constructed response scoring arts, an “answer” might very well span multiple physical sheets of paper.

In a next preferred step, a test taker's answer sheet(s) will be selected (step 110) and scanned (step 115), thereby converting it to digital form. As is explained more fully hereinafter, it is preferable that the scan be a multi-tonal scan, rather than the conventionally utilized bi-tonal (e.g., 1-bit, two-level or “zero-one”) scan. Although the multi-tonal scan will require more storage space than would be required for a bi-tonal scan of the same sheet, the advantages of a multi-tonal scan include improved readability of the answer sheet by a scorer. Additionally, it may be preferable in some instances to scan and store the image in both forms (multi-tonal and bi-tonal) at the outset, as the stored bi-tonal image will occupy relatively little additional disk space.

As a next preferred step, the scanned image will be identified (e.g., by comparison with the blank master test forms) and the regions of the scanned test image that are expected to contain constructed response answers will be identified (step 125). Such an identification process might additionally include verification that the correct test page has been scanned, that all of the exam pages are present, etc. If the answer sheet contains selected response (e.g., multiple choice-type) answers, those answers will preferably be automatically aligned and read (step 120). The technology for doing such is well known to those of ordinary skill in the art.

Of course, after the test has been scanned it will preferably be stored for future retrieval and use (step 130). Typically the scanned image will be stored on magnetic media such as hard disk, although any number of alternative media may also be used (e.g., CD-RW, DVD-RW, nonvolatile RAM, etc.).

Finally, it is anticipated that the test answer sheets from multiple test takers will be scanned into storage (step 125 and loop back to step 110). As is well known to those of ordinary skill in the art typically such answer sheets arrive in large batches from entire schools or school systems. For purposes of economy, it is preferred that all such answer sheets be scanned and stored at or about the same time, although that is clearly not a requirement.

### PREFERRED EMBODIMENTS

### Test Scoring Using Multi-Tonal Images

Although it has been the conventional wisdom that a scorer needs access to only a bi-tonal (or one-bit per pixel) image, the instant inventors have determined that a multi-tonal image can help a scorer resolve ambiguities in the scanned written responses that might not be otherwise determinable (e.g., where there have been erasures or other smudging of the respondent's answer). Bi-tonal images conventionally show each pixel either as black or white. While scanner sensitivity can be adjusted to some extent, portions of answers that are written very lightly on a page (for example, in light blue ink or in pencil) may be scanned as white rather than black and hence would be invisible to the scorer. This is particularly likely to occur when the darkness of the test taker's writing varies within the answer as, for example, when an answer is written partially in black ink and partially in pencil. However, transmission of a multi-tonal image to an individual scorer over a low-speed connection, or multiple transmissions to multiple scorers over a high-speed network, can potentially swamp the communication conduit's bandwidth.

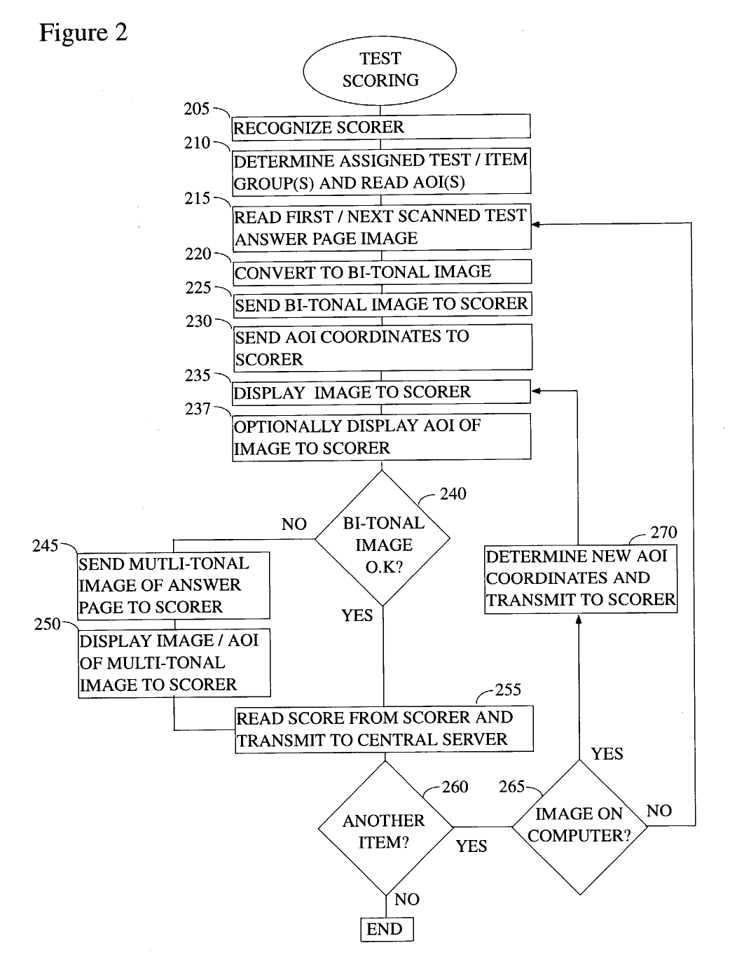

As a consequence, and according to a first preferred embodiment of the instant invention and as is generally illustrated in FIG. 2, there is provided a constructed response scoring system that utilizes multi-tonal (rather than bi-tonal) scanned images of the test-taker's answer page. In the preferred arrangement, each test answer page will be scanned as a multi-tonal image and stored in that format on a central server. However, rather than initially sending the larger multi-tonal image to the scorer, a smaller bi-tonal image will be sent first, with the multi-tonal image being sent only upon request of the scorer. This system and method has the general advantage of reducing the bandwidth that is necessary to transmit images to an individual scorer (who may be connecting to the server via a 56K modem), while making it possible for a scorer to use the more detailed information viewable within the multi-tonal image if that is desired.

As a first preferred step, the scorer will log into a central server and be recognized (step 205). In some cases, the scorer will contact the central server using a modem/ISP combination, and may have limited bandwidth over which to transmit information. However, in other cases the scorer might be in communication with the server via a LAN, VPN, or other means that provide faster communication and more bandwidth.

As a next preferred step, the test answers that have been assigned to this particular scorer will be determined (step 210). Typically this determination will be made by database lookup within the central server, but it is also possible that the scorer might simply be prompted to provide this information. Additionally, as is well known to those of ordinary skill in the art it is common practice for a scorer to be assigned a “set” of (usually) related answers to score within each exam, i.e., an “item group”. A set of items might include any number of answers, but often comprises one to three different answers.

Preferably, next a scanned test answer page containing a test answer assigned to this scorer will be obtained from storage(step 215). As has been explained previously, this image will preferably be a multi-tonal image which was previously scanned and stored on the central server or on another computer in electronic communication with the server (e.g., another computer that is connected to the server via an internal network or an external network such as the Internet).

In the preferred embodiment, the AOI is manually preselected during test preparation (step 105) or could be estimated automatically using electronic means (such as OMR). The AOI defines that portion of the scanned image that contains the test answer that has been assigned to this scorer. Thus, if the region/pixels defined by the AOI is extracted from the scanned answer sheet image, the test taker's answer will presumably be included therein, although it is not uncommon to find answers that are written at least in part outside of the designated region (or, for that matter, left entirely blank). Obviously, the AOI could be as large as the entire scanned page or might even span multiple scanned pages, depending on the nature of the test and the answer.

As a next preferred step, the scanned test image will be converted to a bi-tonal image via any number of methods well known to those of ordinary skill in the art (step 220). For example, in a first preferred variation, all pixels greater than some predetermined value will be arbitrarily set equal to, say “1” and those less than (or equal) to the predetermined value will be set equal to “0”. Further, and as a preferred part of this process, the resulting image will be “packed” so that, rather than having four-bit or eight-bit pixels, it will have one-bit pixels, thereby reducing substantially the size of the image file. Of course, those of ordinary skill in the art will recognize that, rather than converting the multi-tonal image to a bi-tonal image at the time it is needed by a scorer (e.g., “on demand”), it is certainly possible that both images could be obtained at the outset and stored together on disk, e.g., both images might be obtained from the scanner during the original scanning, the multi-tonal image could be immediately converted to a bi-tonal image via software, etc. Thus, it should be clear that the method of conversion, and the time at which the multi-tonal image is converted to a bi-tonal image, is immaterial to the operation of the instant invention.

Next, the bi-tonal image of the entire answer page will preferably be transmitted electronically to the scorer (step 225) and displayed at his or her local terminal (step 235). Further, it is preferred that the coordinates that define the AOI also be transmitted (step 230), so that the software that displays the answer images will know which portion of the test is to be displayed to the scorer (step 237). As will be explained in greater detail below, in the preferred embodiment the software that handles this function will be implemented as a plug-in or other application program that executes within a conventional browser such as Microsoft Internet Explorer or similar network based viewing application.

As a next preferred step, the scorer will determine whether or not the bi-tonal image is sufficient for his or her purposes (step 240), i.e., whether the transmitted image is “readable” or whether the multi-tonal image (with its additional visual information) should be downloaded to the scorer's computer for viewing. As previously explained, the additional tonal variations present within a multi-tonal scan can make it possible to resolve marks that would otherwise be indeterminate in the bi-tonal scan. However, the greater bandwidth required to transmit the multi-tonal image argues against its use on a routine basis and, in many cases, the bi-tonal scan will yield sufficient detail.

In those circumstances where the originally-transmitted bi-tonal image is adequate, the score will be read from the scorer and transmitted back to the central server 255. However, if the scorer cannot clearly read the bi-tonal image, or merely wishes to confirm what was read, the multi-tonal image will be sent (step 245) and displayed to the scorer either partially (e.g., the AOI only) or in its entirety (step 250), in advance of obtaining the score for this test answer from him or her (step 255).

Obviously, the preferred usage of the instant embodiment is with the scorer who grades a series of test answers, either the same single answer on many different exams or multiple answers on each exam. Thus, a preferred next determination is whether or not the scorer wishes to grade another item (step 260). If the response is “no” this aspect of the instant inventive method would normally terminate. However, if the scorer wishes to proceed, it will preferably be determined (step 265) whether the next image has already been downloaded to the scorer's computer (e.g., if the image were already present in the scorer's browser cache), in which case only the AOI coordinates for the next question need be sent to the scorer (step 270). Alternatively, a new scanned page is downloaded from the server, preferably in the one-bit format (steps 215 through 235). In some instances the multi-tonal image might automatically be initially sent to the scorer, e.g., where the scorer previously asked for the multi-tonal image in connection with a different question on this same test page.

### Preloading Answer Page Images

Those of ordinary skill in the art will recognize that when a scorer requests a graphic image containing a test item, a delay necessarily follows while the requested bitmap image is transmitted via the interconnecting network. To the extent that the scorer is required to do this for each new page that is viewed, the scorer's productivity will tend to decrease.

Thus, and according to another preferred aspect of the instant invention, there is provided a method for improving the throughput of a scorer, where a first graphic image containing a test answer is loaded onto the user's computer and, thereafter, a second graphic image is loaded as a hidden graphic so that it will be immediately available to the scorer when he or she requests a subsequent test image. In the preferred arrangement, the scorer will be connecting to the server via the Internet and will be utilizing a conventional web browser such as Microsoft Internet Explorer. It is additionally preferred that custom software which is written as an application “plug-in” be utilized to handle the graphic display steps discussed below, so that the system will work with a conventional web browser to which the scorer already is accustomed.

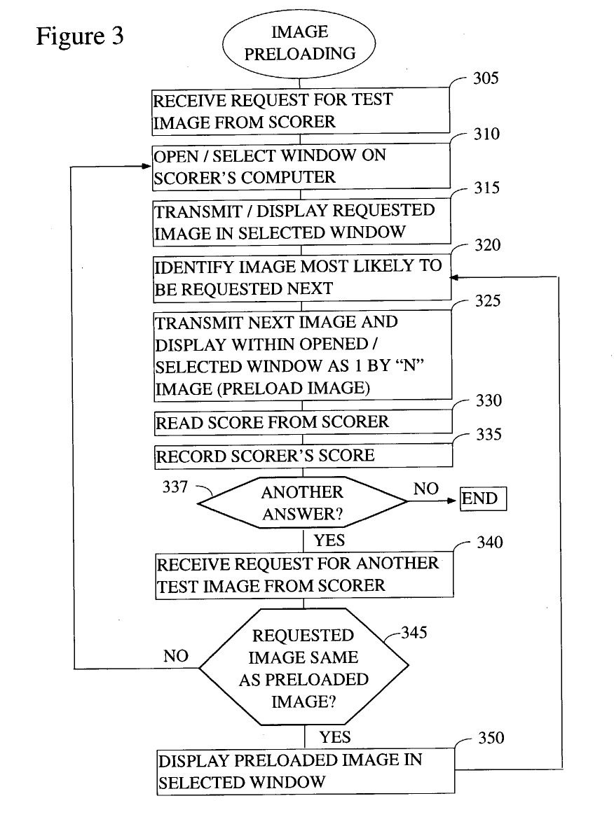

Turning now to FIG. 3, in the preferred embodiment of the instant exam scoring method, as a first step a central server will receive a request from a user to transmit a first test image to the scorer's local computer (step 305). In response to this request, a graphic window will be opened on the user's local display device or a currently open window will be selected (step 310). This window will be used to hold and display the selected graphic image after it is transmitted to the scorer (step 315).

As a next preferred step, the instant method continues by determining which graphic image is likely to be next requested by the scorer (step 320). In most instances there will be a fairly clear choice as to which graphic image will be requested next (e.g., if the scorer is scoring exam answer #7 on each test, it is likely that when he or she finishes with the current test image, answer #7 on the next exam will be requested).

Then, while the scorer is examining and scoring the transmitted and currently displayed graphic image, the image that is determined likely to be requested next is downloaded to the user's computer as a hidden graphic (step 325), thereby concealing its loading from the user. As is indicated in FIG. 3, in the preferred arrangement, the transmission of the next graphic image as a hidden graphic will be accomplished by loading the graphic, not configured in its usual aspect ratio, but rather as an image that is 1 pixel high by N pixels wide, where N, for example, is the width of the display window. This image will appear (if it can be viewed at all) as a horizontal line across the active window. Note that this particular arrangement forces the browser (or other display software) to load the entire image in its full resolution. Note further that by choosing the location of the loaded graphic to be below the currently viewable region of the active window, the loading of this graphic will be invisible to the scorer, i.e., it is a “hidden graphic” which does not interfere with or distract from the scorer's view of the test item that is currently under consideration.

It should also be clear that this is only one of many methods of “hiding” from the user such a graphic while it is loaded. Alternative means of creating this sort of hidden graphic include loading the test image into another window (i.e., one that is different from one containing the test answer under consideration), or preloading the next image into RAM or other storage separate from the display area (i.e., so that it is not viewed or viewable at all). In any case, it is critical to the operation of the instant invention that the preloaded graphic image not obstruct or otherwise distract the scorer. Thus, when the term “hidden graphic” is used herein, it should be broadly interpreted to include any arrangement wherein a first test image is presented to the scorer and then a second/hidden graphic is loaded in such as way as to be largely invisible until needed.

The preferred system and method is based on the following observation about Internet browsers in general. When a browser is instructed to display a graphic image (which would typically be done via programming instructions that are written in HTML, Java, JavaScript, or some other programming language), one component of that instruction is the size within the browser window that the graphic is to be displayed. Typically, the browser loads the original image into its cache and then resizes it as is required by its programming for display on the user's screen. Although the user might see only a small representation of the image on his or her screen (e.g., a line), the full image is actually stored locally on the user's hard disk for later loading.

Thus, when the user requests the “next” page, that page will be read from local hard disk (e.g., from browser cache) and displayed for the user, now at a viewable size and in its correct proportion. This gives the impression to the user that the image has loaded almost instantly and reduces the wait time that would otherwise be necessary if the image had not been pre-loaded.

Turning again to FIG. 3, as a next preferred step, the server will wait for the user to transmit a score for the currently displayed test answer (step 330), after which the score will be recorded as is usually the case (step 335). Following that, it would be customary for the scorer to request a next test answer/test image (step 340) from the server.

If the requested image is the one that has been preloaded as a hidden graphic (steps 345 and 350), it can be immediately displayed (at a viewable height and width). This obviously is much faster than having the user wait for his potentially-slow communications link to download the next requested answer image after it has been requested.

Of course, if the scorer selects a different image from that which was predicted by the instant method, it will be necessary to load the image from the server over the communications link (steps 345 and 310). However, in those cases where the scorer does as expected, it is possible to substantially increase the productivity of that scorer via the use of this system and method.

### Automatic Zoom

According to still another preferred arrangement, there is provided a method of assisting a scorer to score a digitally presented test answer, wherein the subject answer is first presented to the scorer within the context of a larger image and then automatically zoomed to show only the AOI of the test answer.

The importance of this arrangement is as follows. In order to increase the efficiency of the scorer, it is advantageous to focus the attention of the scorer on the portion of the scanned answer page that contains the response to the question that the particular scorer has been asked to grade. Clearly this will reduce the time that the scorer would otherwise expend in locating an answer on a full-page scan of answers.

However, a fixed-region AOI (or even the best algorithmic determination of the AOI) may occasionally fail to capture the entire response of the test taker. When a scorer is presented with a graphic image that contains only the AOI, it may be difficult or impossible to determine whether the AOI includes the entirety of the test taker's constructed response. For example, it is entirely possible that the response within the AOI might appear to be punctuated to give the impression that it is complete but in actuality, a new sentence or paragraph may be contained outside the predefined AOI. For this reason, the system of the instant invention will display a larger region of the test answer page in an effort to allow the scorer to determine whether the AOI encompasses the entire answer.

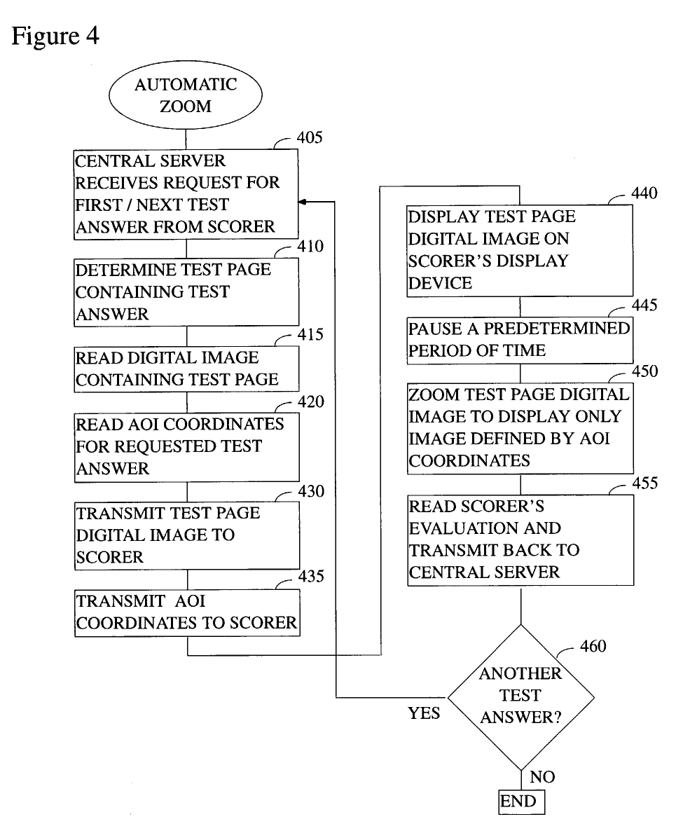

As is indicated in FIG. 4, according to a preferred embodiment a central server will receive a request for a test answer from a scorer (step 405). In response to this request, it will be determined which test page contains the test answer requested (step 410) as is conventionally done. The digital image that contains the test answer and the AOI coordinates will next be read (step 415 and 420) from disk or other storage media.

As a next preferred step, the test answer page and associated AOI will be transmitted to the scorer's computer (steps 430 and 435). Upon receipt of this information, the local display program will select a region of the test answer page that is larger than the AOI for display on the scorer's screen (step 440). Thus, the information within the AOI, as well as additional information that surrounds it, will be displayed to the scorer at this step. Then, after a predetermined period of time (step 445) or, alternatively, upon receipt of a signal from the scorer, the display will be zoomed in (step 450) to show only the information contained within the AOI for this test answer. Note that it is not necessary that there be any “zooming” animation and, in the simplest case, the “zoom” would consist merely of replacing the first (larger-view image) with the second (the image containing the actual AOI).

Additionally, it is preferred (but not required) that the scorer be assisted in his or her location of the AOI for the current test answer within the larger image by placing some sort of highlighting around the boundaries of the predefined AOI. That is, in one preferred embodiment a semi-transparent yellow “stripe” might be drawn on the larger (e.g., full page) graphic image around the AOI. In another preferred arrangement, the portion of the larger image outside of the AOI will be darkened somewhat (e.g., by subtracting a small positive value from each pixel intensity), thereby leaving the “brighter” AOI easily identifiable. In still another preferred arrangement, the AOI will be highlighted in yellow and the non-AOI region generally given a red tint. Thus, the scorer will be able to quickly locate the subject test answer within the larger graphic display of test answers.

Further, it should be clear that in some circumstances the scorer would want to preempt the transition to the more detailed image and, in such a circumstance, it would be within the spirit of the instant invention to allow the user to issue a command (e.g., press a particular key or key combination, or click the mouse, etc.) to stop the transition. Alternatively, the transition to the second view could be made to be manually initiated, with receipt of a key, key combination, or mouse click (for example) being the signal to transition to the more detailed AOI view. Additionally, it may be that the scorer, after viewing only the AOI image, will wish to return to the wider view and, in such a case, the software will preferably provide this functionality.

Returning now to FIG. 4, in a next preferred step 455 the scorer's evaluation of the current test answer will be transmitted back to the central server where it will preferably be recorded and reported as is typically done. Of course, if the scorer wishes to score additional test answers (step 460), the instant method will accommodate that desire as indicated in FIG. 4.

Note that, although in the preferred embodiment the entire page containing the subject test answer is first displayed, that obviously need not be done in every case and, at the option of the user or programmer, a smaller region might be first displayed. However, it is critical to the operation of this aspect of the instant invention that the image first displayed to the scorer be larger than the defined AOI so that the scorer will become aware of any portion of the answer that was recorded outside of the AOI. Additionally, it should be clear that the image of the zoomed AOI could obviously include additional information from the scanned test page beyond that minimally required to display the actual test answer. For example, in one preferred arrangement the region covered by the zoomed AOI is selected by determining the first scan line in the transmitted AOI and then, starting at that scan line, displaying as much of the scanned test page image as will fit within the current window or screen, even if that includes part of the next test answer.

Finally, it is contemplated by the instant inventors that at least part of the method taught herein would preferably be implemented as a plug-in or other executable program (e.g., one using Active-X) that would run within Microsoft Internet Explorer or a similar network based viewing application.

### Third Scorer Consultation

According to still another preferred embodiment, there is provided a method of automatically determining when a third scorer should be consulted based on the scores to a test answer provided by two different assigned scorers, i.e., when a “tie breaker” should be consulted according to the criteria established by the testing authority. It is common to have two scorers evaluate the same test answer in an effort to increase the reliability of the scoring process. In such a case, the two different scorers will usually render approximately the same score and no further scoring is necessary for that test answer. However, in the case where two scorers differ substantially in their assessments, it would be desirable to resolve the matter by involving a third/independent scorer and, further, the decision to involve this scorer should be made automatically based on a comparison between the first two scores.

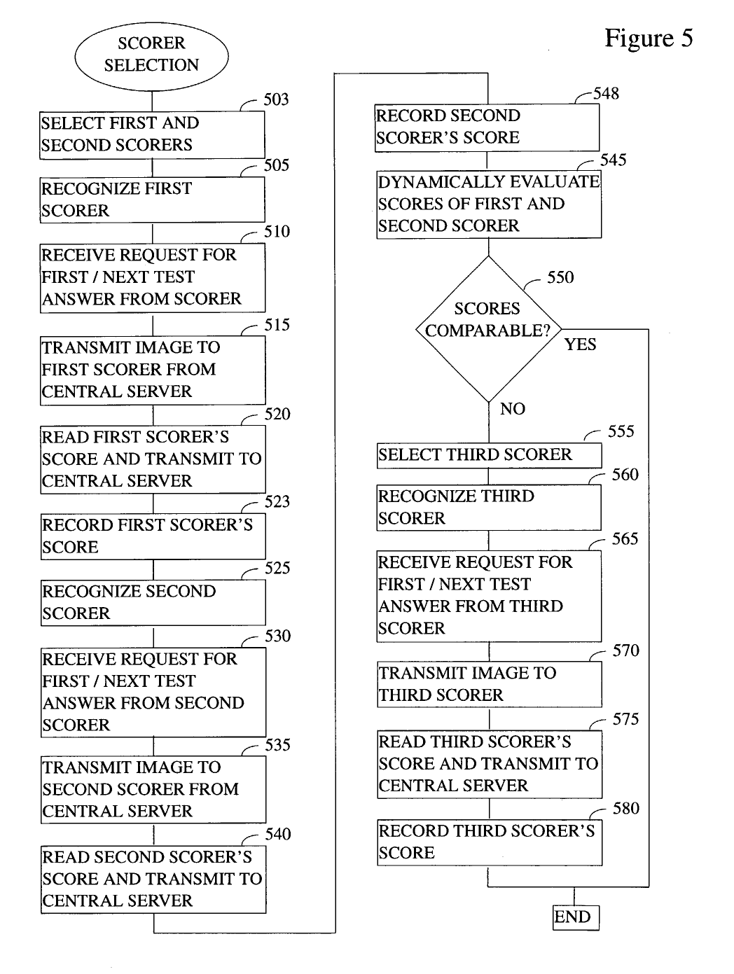

As is indicated in FIG. 5, as a first step 503 the first and second scorers will be selected. Those of ordinary skill in the art will understand that whether this decision is made in advance, or made dynamically based on the scorers that are available and connected to the system, is immaterial for purposes of the instant invention. As is generally the case with scorers, a next preferred step would involve each scorer “logging in” to the system and being recognized (steps 505 and 525).

Next, a request will be received from the first scorer to transmit a digital image containing the subject test answer to his or her computer terminal (steps 510 and 515), where it will be evaluated and the resulting score will be transmitted back to the central server (step 520) where it will be recorded (step 523).

The second scorer's score will be collected in a similar manner and such collection would preferably involve the steps of recognizing him or her (step 525), receiving a request for a test answer (step 530), transmitting the image of the test answer to that scorer (step 535), receiving the score, and transmitting the second scorer's score to a central server (step 540) where it will be recorded (step 548).

Then, after the scores have been collected and recorded (steps 523 and 548), a decision will automatically be made based on predetermined mathematical, statistical, or other criteria (step 545) as to whether or not the two previously obtained scores are consistent or, alternatively, whether a third scorer should be consulted (steps 550 through 580).This decision need not be made at the moment that the second score is tendered but might instead be deferred until such time as a third scorer becomes available, (e.g., the scores database is searched and the scores are compared at the time when a third scorer who is qualified to resolve the dispute requests an item from the system). As an example of how this method would operate in practice, if the difference between the first and second scorer's scores exceeds some predetermined value (e.g., a difference of “1” or more on an answer that is scored from one to five), a flag would be set to indicate that this question should be reviewed by a third scorer.

If the two scores at least approximately agree (or meet whatever other standard for finality has been set by the testing authority) (step 550), no further scoring activity will be necessary with respect to this answer, although it is certainly possible that the same answer will be accessed later for other purposes.

In the event that the two scores require a third scorer, according to the criteria established by the testing authority, a third scorer will be selected (step 555). After that scorer is identified to the system (step 560) and a request is received for a test answer (step 565), an image containing the test answer will be transmitted (step 570). As is usually the case, the scorer's score will be transmitted (step 575) to the central server and recorded (step 580). Note that the selection of the third scorer may or may not involve the selection of a specific scorer but could be instead be based on the next scorer who is recognized by the system (e.g., the next available scorer who is authorized to grade the disputed test answer) who is authorized to act as a third reader. Normally, such “third scorers” will be senior scorers with more experience than is required for the first and second scorers.

It should be noted that the method described above is readily adapted to the case where there are more than two “initial” scorers and more than one “third” scorer. That is, it is certainly possible, and well within the spirit of the instant invention, that there could be, for example, four scorers that initially review a particular test answer. Based on their combined scores, a determination will be made as to whether a “tie-breaker” will be needed (e.g., if the difference between the highest and lowest scores exceeds one). The “third” scorer then might be a senior individual or multiple individuals (e.g., a committee) who review the answer and make a final determination. Thus, when the term “scorer” is used herein, that term should be understood to include the possibility it might refer to more than one individual.

Those of ordinary skill in the art will understand that there are any number of ways to obtain a single final score based on the multiplicity of scores provided by the process described above, if such a final score is desired. Clearly, the final score could be obtained automatically (e.g., any mathematical combination of the three scores obtained from the three different scorers), or subjectively determined by an end-user/test administrator. For example, it could be the numerical average of the multiple scores, the median (middle) of the scores, either the first or second actual score (depending on which of the initial scores the third score is closer to), or otherwise determined according to the pre-established criteria of the testing authority.

### Scorer Evaluation

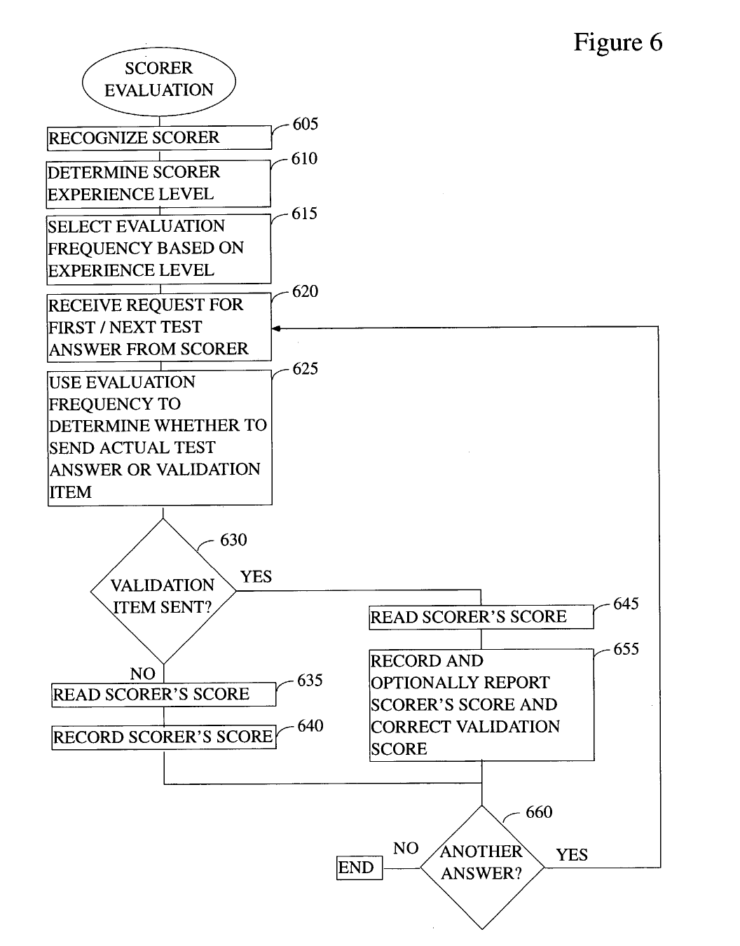

According to another preferred embodiment of the instant invention and as is set out in FIG. 6, there is provided a method for evaluating scorers by presenting validation answers thereto, wherein the frequency at which the validation answers are presented is determined as a function of the experience level of the scorer. In more particular, a scorer with less experience will be given validation answers more frequently than one with more experience in scoring test answers. It should be understood that other criteria, such as demonstrated sub-par performance, could also be used as a basis for increasing the frequency of validation answers.

Turning to FIG. 6, in a preferred arrangement a scorer will be recognized (e.g., he or she will log in) by the central server (step 605). Given the scorer's identification, a determination will be made as to the experience level of the scorer (step 610). Obviously, that determination could be done in many ways including consulting a local database to see how many actual answers had been scored by that scorer, relying on information from the scorer related to years of experience, allowing some third party (e.g., the scoring director) to arbitrarily determine the experience level of each scorer, etc. It should be clear, and those of ordinary skill in the art will recognize, that the method by which the experience level of the scorer is determined is unimportant to the operation of the instant embodiment. Those of ordinary skill in the art will recognize that one purpose of providing a scorer with validation answers is to ensure that the scorer is accurately scoring test items.

Given the scorer experience level, a next preferred step would involve the determination of the evaluation frequency for this scorer (step 615). This determination could take many forms but among the preferred embodiments are assigning the scorers to a plurality of ordered groups (e.g., “inexperienced”, “moderately experienced”, “very experienced”, etc.), or some numerical assessment of experience (e.g., “2 years experience”, “500 answers graded”, etc.). In any case, the evaluation frequency will preferably be inversely proportional to the amount of experience, with less experienced scorers being presented with validation items more often than experienced ones. The same general principles preferably will guide the determination of evaluation frequency where other criteria for selection were employed. For example, where quality of prior scoring target scorers to receive additional validation answers, the evaluation frequency will preferably be inversely proportional to the quality of the scoring.

As a specific example of the sorts of evaluation frequencies that might be utilized in practice, according to one preferred embodiment inexperienced scorers will receive a validation item every tenth answer, where more experienced scorers will be given such answers somewhat less frequently. Obviously each validation answer might be sent according to a deterministic pattern (e.g., every 10^{th}, 50^{th}, etc., item transmitted to the scorer), or randomly (e.g., with probability 0.1 that each time a set of items is sent to the scorer that among those items will be one or more validation answer), etc.). In a preferred embodiment, when a scorer is recognized by the system, a determination is made as to his or her validation item frequency which is expressed as a probability (e.g., 0.1). Then, each time a new test answer set is requested, a random number is generated and, if so indicated (e.g., if the randomly generated value is less than 0.1), a one or more validation items are included among those items transmitted to the scorer. In another preferred embodiment, the validation item frequency is expressed as a percentage. Answers are assigned to the scorer in sets, rather than one at a time. Within each set, the designated percentage of answers are validation answers, preferably randomly distributed within the set. Those of ordinary skill in the art will understand how other variations are possible and can readily be implemented.

As a next preferred step, when a request for a next test item is received from the scorer (step 620) a determination will be made based on the evaluation frequency whether to send actual test items or to include a validation item among those items (steps 625 and 630). In the event that an actual test item is sent, the method continues as is customary in the test scoring arts with the reading of the scorer's score (step 635), the recording of that scorer's score (step 640), and moving to another test item if appropriate (step 660).

However, if the determination is made to send a validation item, in the preferred arrangement the scorer's score will be read (step 645), transmitted back to the server and recorded, and optionally the correct validation score will be reported to the scorer (step 655).

### Scorer Feedback

Finally, and according to still another preferred embodiment, there is provided a rating system for use by a scorer of constructed response tests, wherein the scorer is presented with a validation answer, after which the scorer's score to that answer is stored in a central server or similar computer which is in electronic communication with that of the scorer. Optionally, the scorer will be presented with the “correct” response after his or her own evaluation has been tendered, thereby allowing the scorer to improve his or her own rating skills by comparison with the “correct” scoring for this item. Optionally, the scorer will also be presented with his or her own previous scoring, so that a direct comparison may readily be made between the two.

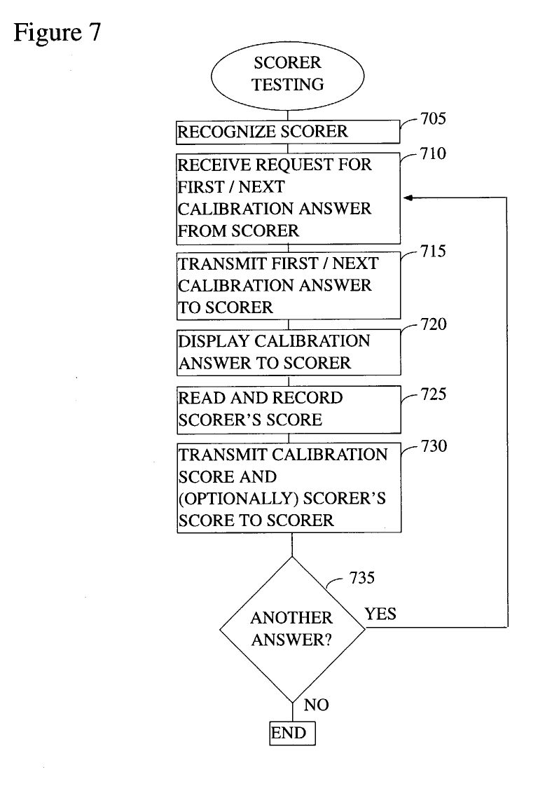

As is indicated in FIG. 7, according to the preferred embodiment of the instant invention as a first step a scorer will be recognized by the central server (step 705). As is customary in these sorts of systems, a request will be received from the scorer for a first (or next) calibration answer (step 710), after which a calibration answer is sent to the scorer (steps 715). The calibration answer is displayed to the scorer (step 720) and the scorer's score is read and recorded (step 725). Then, the calibration score and, optionally, the scorer's own previously-entered score, will be transmitted to the scorer (step 730). If the scorer requests another answer (step 735), the previous steps will be repeated.

The purpose of this step is not so much to inform the scorer whether he or she was right or wrong, but rather to help him or her improve in the rating process. Note that the calibration score might be a single numerical value (i.e., the score that has been determined to be correct for this item) or it might be an image that contains the calibration item with annotations added to show where points should have been awarded or deducted, or both the score and annotated image. Calibration answers usually are used in a training session, where the scorer is given a test answer specifically chosen to illustrate a certain score or to illustrate how fine distinctions between answers lead to different scores. The calibration answer can thus be used to teach the scorer why a specific answer deserves a certain score. In the calibration setting, the scorer is ordinarily aware that the answer is being used as a training tool and the scorer is usually immediately given feedback. In contrast, pre-scored items that are assigned to scorers during actual grading sessions usually are referred to as validation answers and are given to scorers without their knowledge. Scorers do not know whether a specific validation answer is an actual test answer or one provided as a quality control check on their scoring. While scorers are aware that they are being evaluated, they do not know which answers are being evaluated, as opposed to the calibration setting.

### CONCLUSIONS

It should be noted and remembered that, although the term “bi-tonal” image has principally been used to refer to an image whose total bits per pixel is no more than 1, including bit width and depth, in general the term bi-tonal—as used herein—should not be so closely limited. That is, a bi-tonal image could also be used to refer to an image with a bit width and depth of only a few bits which, by comparison with a full width and depth image (e.g., eight or more bits per pixel), would seem relatively small. Thus, in those circumstances herein where a “bi-tonal” image is sent to the scorer ahead of a “multi-tonal” image, it should be understood that the instant invention would operate substantially the same if the “bi-tonal” image were, say, a two bits per pixel image (i.e., each pixel could assume four possible intensity levels). Similarly, a multi-tonal image should be understood for purposes of the instant disclosure to be at least a two bits per pixel image or an image whose bit width times its bit depth is greater than one. It is only required that the bit width times the bit depth of the multi-tonal image be greater than the bit width times the bit depth of the bi-tonal image. Thus, mathematically speaking, it must be that if N is the product of the bit depth and bit width of the “bi-tonal” image, then the product of the bit depth and bit width of the “multi-tonal” image must be at least N+1.

Additionally, it should be noted and remembered that, although the preferred embodiment utilizes a “central server”, e.g., a computer accessible via a network which contains enough storage space for the images, it should be clear to those of ordinary skill in the art that the server might actually consist of one or more separate computers that are interconnected via an internal or external network, each of which might have its own storage available either directly connected thereto or accessible via a network or other electronic means.

It should further be noted that although some preferred embodiments of the instant invention operate as a plug-in (or, alternatively an Active-X program) that is executable within an Internet browser such as Microsoft Internet Explorer, the instant invention should not be limited to this mode of operation. Microsoft Internet Explorer was chosen for use with the preferred embodiment because of its wide availability and relative platform independence and, indeed, the broad availability of this program makes it an attractive choice in practice. However, it should be clear that any other Internet browser (e.g., Netscape, Mozilla, etc.) could be used instead. Even more generally, the instant invention could be implemented by way of custom software which handles communications between the server and scorer via some sort of network (e.g., LAN, WAN, VPN, etc.).

Although the invention disclosed herein is preferably used in connection with the grading of standardized tests, its potential usefulness extends far beyond that. Thus, when the word “test” is used herein, that word should be interpreted in its broadest sense to include survey responses and any other sort of information that has been collected from any segment of the public—to include collection of information from public and private institutions, commercial entities, and/or governmental bodies/agencies/institutions, etc.—which must be rated, scored, or otherwise evaluated.

While the inventive device has been described and illustrated herein by reference to certain preferred embodiments in relation to the drawings attached hereto, various changes and further modifications, apart from those shown or suggested herein, may be made therein by those skilled in the art, without departing from the spirit of the inventive concept, the scope of which is to be determined by the following claims.

What is claimed is:

1. A method of scoring constructed response test questions, comprising the steps of:
(a) selecting an answer sheet having at least one test answer thereon;
(b) selecting a test answer from among said at least one test answers on said answer sheet;
(c) scanning at least a portion of said selected answer sheet containing said selected test answer, thereby producing a multi-tonal digital image;
(d) obtaining a bi-tonal digital image of said answer sheet at least approximately corresponding to said multi-tonal digital image, said bi-tonal image containing at least said selected test answer;
(e) transmitting at least a portion of said bi-tonal digital image containing said selected test answer to a scorer computer having a display device in electronic communication therewith;
(f) displaying at least a portion of said transmitted bi-tonal digital image on said display device to a scorer;
(g) receiving from the scorer a request to send at least a portion of said multi-tonal image corresponding to said displayed portion of said transmitted bi-tonal digital image;
(h) transmitting to said scorer computer at least a portion of said multi-tonal image according to the scorer's request;
(i) displaying on said display device at least a portion of said transmitted multi-tonal image containing said selected test answer to the scorer;
(j) reading a score for said selected answer from the scorer; and,
(k) recording said score from the scorer.

2. A method of scoring constructed response test questions according to claim 1, wherein step (f) comprises the steps of:
(f1) determining an AOI corresponding to said selected test answer, said AOI being defined by one or more coordinate pairs,
(f2) transmitting said AOI to said scorer computer,
(f3) using said AOI to display at least a portion of said transmitted bi-tonal digital image to the scorer.

3. A method of scoring constructed response test questions according to claim 1, wherein step (c) comprises the step of scanning said selected test answer sheet, thereby producing a multi-tonal digital image, wherein said multi-tonal image has either a bit width or a bit depth greater than one.

4. A method of scoring constructed response test questions according to claim 1, wherein said multi-tonal image is a gray scale image having at least 256 different shades of gray.

5. A method of scoring constructed response test questions according to claim 1, further comprising:
(1) reporting said score from the scorer.

6. A method of scoring constructed response test questions according to claim 1, wherein steps (a) through (k) are performed in the order recited.

7. A method of scoring constructed response test questions according to claim 1, wherein step (e) comprises the step of transmitting via the Internet at least a portion of said bi-tonal digital image containing said selected test answer to a scorer computer having a display device in electronic communication therewith.

8. A method of scoring constructed response test questions according to claim 1, wherein said bi-tonal image is a 1-bit depth and a 1-bit width image.

9. A method of scoring constructed response test questions according to claim 1, wherein said bi-tonal image has a bit-tonal bit width and a bi-tonal bit depth, said bi-tonal bit width multiplied times said bi-tonal bit depth being equal to Ni and wherein said multi-tonal image has a multi-tonal bit width and a multi-tonal bit depth, said multi-tonal bit width multiplied times said multi-tonal bit depth being greater than or equal to N+1, where said N is greater than or equal to one.

10. A method of scoring constructed response test questions, wherein is provided a central server containing a plurality of digital test answer sheets stored therein, comprising the steps of:
(a) selecting a first test answer;
(b) selecting a first digital test answer sheet containing said first test answer from among said plurality of digital test answer sheets;
(c) transmitting at least a portion of said first digital test answer sheet containing said first test answer to a scorer computer having a display device in electronic communication therewith;
(e) displaying at least a portion of said transmitted first digital test answer sheet on said display device to a scorer;
(f) selecting a second digital test answer sheet, said second digital test answer sheet containing at least one test answer therein, at least one of said at least one test answers being one that will likely be selected next by the scorer;
(g) automatically transmitting at least a portion of said second digital test answer sheet to said scorer computer;
(h) loading at least a portion of said transmitted second digital test answer sheet on said scorer computer as a hidden graphic;
(i) reading a score for said first test answer from the scorer;
(j) transmitting said score to the central server;
(k) receiving a request from the scorer for a next test answer;
(l) if said next test answer is one of said at least one test answers, immediately displaying said second test answer using said hidden graphic; and,
(m) if said next test answer is not one of said at least one test answers, transmitting a request to said central server for said next test answer.

11. A method of scoring constructed response test questions according to claim 10, wherein steps (a) through (m) are performed in the order recited.

12. A method of scoring constructed response test questions according to claim 10, wherein said first answer sheet and said second answer sheet are a same answer sheet.

13. A method of scoring constructed response test questions according to claim 10, wherein a hidden graphic is a graphic image one pixel high.

14. A method of scoring constructed response test questions according to claim 10, wherein a hidden graphic is stored in RAM on said scorer computer.

15. A method of assisting in the scoring of constructed response test questions, comprising the steps of:
(a) receiving a request for a test answer;
(b) determining an AOI for said test answer;
(c) selecting a digital answer sheet containing said test answer
(d) transmitting a portion of said digital answer sheet containing said AOI to a scorer computer having a display device in electronic communication therewith, wherein said transmitted portion of said digital answer sheet is greater than said AOI;
(e) displaying at least a portion of said transmitted digital answer sheet containing said AOI on said display device to a scorer, wherein said displayed portion of said transmitted digital answer sheet is greater than said AOI;
(f) automatically zooming said displayed portion of said transmitted digital answer sheet to show approximately only said AOI of said digital answer sheet;
(g) reading a score for said test answer from the scorer; and,
(h) recording said score from the scorer.

16. A method according to claim 15, wherein step (d) comprises the step of transmitting said digital answer sheet to a scorer computer having a display device in electronic communication therewith.

17. A method according to claim 16, wherein step (e) comprises the step of displaying said entire digital answer sheet on said display device to a scorer.

18. A method according to claim 15, wherein step (e) comprises the steps of:
(e1) displaying at least a portion of said transmitted digital answer sheet including said AOI on said display device to a scorer, wherein said displayed portion of said transmitted digital answer sheet is greater than said AOI, and,
(e2) highlighting said AOI within with said displayed portion of said transmitted digital answer sheet.

19. A method according to claim 18, wherein step (e2) comprises the step of highlighting said AOI within said displayed portion of said transmitted digital answer sheet by darkening said displayed portion of said transmitted digital answer sheet outside of said AOI.

20. A method according to claim 15, wherein step (f) comprises the steps of:
(f1) pausing a predetermined period of time, and,
(f2) automatically zooming said displayed portion of said transmitted digital answer sheet to show approximately only said AOI of said digital answer sheet;

21. A method according to claim 15, wherein step (f) comprises the steps of:
(f1) pausing until a signal is received from the scorer, and,
(f2) automatically zooming said displayed portion of said transmitted digital answer sheet to show approximately only said AOI of said digital answer sheet;

22. A method of scoring constructed response test questions according to claim 15, wherein steps (a) through (h) are performed in the order recited.

23. A method of scoring constructed response test questions, wherein is provided a central server containing a plurality of images of constructed response test answers, comprising the steps of:
(a) selecting a first scorer and a second scorer;
(b) selecting an answer image from among said plurality of images of constructed response test answers;
(c) transmitting at least said answer image to a first scorer computer having a first display device in electronic communication therewith;
(d) displaying at least a portion of said transmitted answer image on said first display device to the first scorer;
(e) reading a first score for the answer image from the first scorer;
(f) transmitting at least said answer image to a second scorer computer having a second display device in electronic communication therewith;
(g) displaying at least a portion of said transmitted answer image on said second display device to the second scorer;
(h) reading a second score for the answer image from the second scorer;
(i) comparing said first score and said second score;
(j) determining based on said comparison of said first and second scores whether said scores are comparable;
(k) if said first and second scores are comparable, taking no further action with respect to scoring of said selected answer image; and,
(l) if said first and second scores are not comparable,
(l1) selecting a third scorer,
(l2) transmitting at least said answer image to a third remote scorer computer having a third display device in electronic communication therewith,
(l3) displaying at least a portion of said transmitted answer image on said third display device to the third scorer,
(l4) reading a third score for the answer image from the third scorer, and,
(l5) reporting and recording said third scorer's score.

24. A method of scoring constructed response test questions according to claim 23, wherein steps (a) through (l) are performed in the order recited.

25. A method of scoring constructed response test questions according to claim 23, wherein step (l11) comprises the steps of:
(i) recognizing a new scorer,
(ii) determining whether the new scorer is qualified to score non-comparable test items, and,
(iii) if the new scorer is qualified to score non-comparable test items, selecting the new scorer as the third scorer.

26. A method of scoring constructed response test questions according to claim 23, wherein said first and said second scores are not comparable if a numerical difference between said first and said second scores is greater than a predetermined value.

27. A method of scoring constructed response test questions according to claim 26, wherein said predetermined value is greater than one.

28. A method of determining the reliability of a scorer of constructed response test questions, wherein is provided a central server containing a plurality of actual constructed response answer images, and wherein is provided a plurality of control answer images, comprising the steps of:
(a) identifying the scorer;
(b) determining the scorer's experience level;
(c) receiving a request from the scorer for a next test answer;
(d) determining, based on said scorer's experience level, whether to transmit an actual constructed response answer image or a control answer image;
(e) if said determination is made to transmit one of said actual constructed response answer images,
(e1) selecting a constructed response answer image from among said plurality of actual constructed response test answer images,
(e2) transmitting said selected constructed response answer image to said scorer,
(e3) reading a score from said scorer associated with said transmitted selected constructed response answer image,
(e4) reporting said scorer's score; and,
(f) if said determination is made to transmit one of said control answer images,
(f1) selecting a control answer image from among said plurality of control answer images,
(f2) transmitting said selected control answer image to said scorer,
(f3) reading a score from said scorer associated with said transmitted selected constructed response answer image, and,
(f4) recording said scorer's score.
(g) performing steps (c) through (f) as necessary to determine the reliability of the scorer.

29. A method according to claim 28, wherein step (d) comprises the step of determining, based on said scorer's experience level, whether to transmit an actual constructed response answer image or a control answer image, wherein a more experienced scorer is determined to receive said control answer image less frequently than a less experienced scorer.

30. A method of scoring constructed response test questions according to claim 28, wherein steps (a) through (g) are performed in the order recited.

31. A method of scoring constructed response test questions according to claim 28, wherein said determination, based on said scorer's experience level, of whether to transmit an actual constructed response answer image or a control answer image is a probability value.

32. A method of scoring constructed response test questions according to claim 31, wherein said probability value is a probability that an inexperienced scorer will receive a control item.

33. A method of scoring constructed response test questions according to claim 32, wherein said probability that an inexperienced scorer will receive a control item is about 0.1.

34. A method according to claim 28, wherein step (d) comprises the step of determining, based on said scorer's previous scoring of control items, whether to transmit an actual constructed response answer image or a control answer image, wherein a scorer whose previous scoring of control items has been relatively poor is determined to receive said control answer image more frequently than a scorer whose previous scoring of control items has been relatively good.

35. A method of providing feedback to a scorer of constructed response test questions, wherein is provided a server containing a plurality of actual constructed response answer images, and wherein is provided a plurality of control answer images, each of said control answer images having a control score associated therewith comprising the steps of:
(a) receiving a request from the scorer for a next test answer;
(b) determining whether to transmit an actual constructed response answer image or a control answer image;
(c) if said determination is made to transmit one of said actual constructed response answer images,
(c1) selecting a constructed response answer image from among said plurality of actual constructed response test answer images,
(c2) transmitting said selected constructed response answer image to said scorer,
(c3) reading a score from said scorer associated with said transmitted selected constructed response answer image,
(c4) reporting said scorer's score; and,
(d) if said determination is made to transmit one of said control answer images,
(d1) selecting a control answer image from among said plurality of control answer images, said selected control answer image having a selected control score associated therewith,
(d2) transmitting said selected control answer image to said scorer,
(d3) reading a score from said scorer associated with said transmitted selected constructed response answer image, and,
(d4) transmitting said selected control score to the scorer, thereby providing the scorer with feedback.

36. A method of scoring constructed response test questions according to claim 35, wherein said control score is a single numerical value.

37. A method of scoring constructed response test questions according to claim 35, wherein said control score is an annotated version of said selected control answer image.

38. A method of scoring constructed response test questions according to claim 35, wherein said control score comprises a numerical value and an annotated version of said selected control answer image.

39. A method of scoring constructed response test questions according to claim 35, wherein steps (a) through (d) are performed in the order recited.

40. A method of scoring constructed response test questions according to claim 37, wherein step (d4) comprises the step of transmitting to the scorer said selected control score and said score read from the scorer.
